(19) United States
(12) Patent Application Publication
(10) Pub. No.: US 2026/0048779 A1
(43) Pub. Date: Feb. 19, 2026

(54) Body-Worn Hands-Free Wagon-Pulling Strap Device

(71) Applicant: Marcus Evans, Brownsburg, IN (US)

(72) Inventor: Marcus Evans, Brownsburg, IN (US)

(21) Appl. No.: 19/289,188

(22) Filed: Aug. 4, 2025

Related U.S. Application Data
(60) Provisional application No. 63/683,276, filed on Aug. 15, 2024.

(51) Int. Cl. B62B 5/06

(52) U.S. Cl. CPC B62B 5/068

(57) ABSTRACT

A body-worn hands-free wagon-pulling strap device is provided. The device is configured to allow a user to pull a stroller wagon without pulling the wagon via the wagon handle. The device comprises a strap body in a single-strap cross-body configuration or a dual shoulder strap configuration similar to a backpack harness. The strap body further comprises one or more padding components. At least one adjustment fastener may be included to allow incremental customization of strap length for user fit and load positioning. Coupling of the strap to a wagon handle is achieved either by looping the strap around the handle or via a fastener. The strap may further comprise a handle loop to permit optional manual control when required.

### CROSS REFERENCE TO RELATED APPLICATION

The present application claims priority to, and the benefit of, U.S. Provisional Application No. 63/683,276, which was filed on Aug. 15, 2024, and is incorporated herein by reference in its entirety.

### FIELD OF THE INVENTION

The present invention relates generally to the field of stroller wagons. More specifically, the present invention relates to a body-worn hands-free wagon-pulling strap device that enables hands-free pulling of a stroller wagon. Accordingly, the present disclosure makes specific reference thereto. Nonetheless, it is to be appreciated that aspects of the present invention are also equally applicable to other like applications, devices, and methods of manufacture.

### BACKGROUND

Stroller wagons are commonly used for transporting children, recreational items, and equipment across various outdoor terrains, including parks, beaches, and event areas. While wagons offer utility in carrying loads and children, their manual operation often presents significant ergonomic challenges. More specifically, pulling a stroller wagon using traditional hand-held handles typically engages only the upper limbs, which can lead to rapid fatigue, particularly over long distances or uneven surfaces. In many instances, individuals are unable to maintain full control of the wagon due to the necessity of keeping one hand free for other tasks, resulting in compromised maneuverability. The asymmetric application of force during pulling activities may lead to uneven load distribution and postural strain, contributing over time to discomfort or injuries in the neck, back, and shoulders. Moreover, irregular terrain such as sand, gravel, or inclined surfaces exacerbates the difficulty of maintaining directional control and balance during use. In addition, existing wagon designs generally lack ergonomic accommodations that account for human biomechanics in load transport.

Therefore, there exists a long-felt need in the art for a body-worn hands-free wagon-pulling strap device that enables hands-free operation to reduce upper limb fatigue. There also exists a long-felt need in the art for a body-worn hands-free wagon-pulling strap device that distributes pulling force across the torso and shoulders to minimize strain and improve ergonomic load sharing. Moreover, there exists a long-felt need in the art for a body-worn hands-free wagon-pulling strap device that facilitates stable motion and enhanced control over a wagon across variable terrain surfaces.

The subject matter disclosed and claimed herein, in one embodiment thereof, comprises a body-worn hands-free wagon-pulling strap device. The device is configured to allow a user to pull a stroller wagon without pulling the wagon via the wagon handle. The device comprises a strap body in a single-strap cross-body configuration or a dual shoulder strap configuration similar to a backpack harness. The strap body further comprises one or more padding components. At least one adjustment fastener may be included to allow incremental customization of strap length for user fit and load positioning. Coupling of the strap to a wagon handle is achieved either by looping the strap around the handle or via a fastener. The strap may further comprise a handle loop to permit optional manual control when required.

In this manner, the body-worn hands-free wagon-pulling strap device of the present invention accomplishes all the foregoing objectives and provides a device that enables hands-free wagon operation that reduces reliance on upper limbs, thereby mitigating fatigue. The device further distributes the pulling force across the torso and shoulders using ergonomically positioned padding and adjustable straps, thereby reducing strain and promoting load balance. Through these combined features, the device directly addresses the physical challenges and operational inefficiencies associated with traditional stroller wagon pulling, offering a more ergonomic solution.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a body-worn hands-free wagon-pulling strap device. The device is a body-worn accessory designed to enable a user to pull a wagon in a hands-free manner while also allowing engagement of the upper body musculature to enhance mechanical advantage and distribute pulling force across the torso and shoulders. This ergonomic design reduces arm and hand fatigue and improves control over irregular terrain. The hands-free nature of the device further enables users to maintain balance, carry other items, or assist children while walking.

The device is comprised of a strap body fabricated from load-bearing materials such as rubber, thermoplastic elastomers, or high-tensile fibers. An outer surface of the strap body may include a grip area comprised of anti-slip coatings or textured surfaces to prevent strap displacement during motion. The strap body may be configured in either a single-strap cross-body design or a dual shoulder strap configuration. The dual strap design may include a fastener such as a buckle or clasp for maintaining load symmetry and alignment. The strap body may also be comprised of padding enclosed within a breathable, moisture-wicking cover. The padding may include ventilation features to regulate heat and moisture during use.

The strap body may engage with a wagon handle through direct looping or by attachment via one or more fasteners. The fastener may include a pivot point to allow directional compliance, reducing torsional forces on the user's body during changes in movement.

In one embodiment, a handle loop may also be included for optional manual operation, enabling the user to switch between hands-free and manual pulling modes if desired. The handle may incorporate a grip feature for enhanced control during precision maneuvers.

A method of use is also disclosed, comprising steps of providing the device, wearing the strap in a selected configuration, coupling the strap to a wagon handle, walking to pull the wagon in a hands-free manner, and optionally grasping the handle loop for manual control.

Accordingly, the body-worn hands-free wagon-pulling strap device of the present invention is particularly advantageous as it provides a device that enables hands-free wagon operation that reduces reliance on upper limbs, thereby mitigating fatigue. The device further distributes the pulling force across the torso and shoulders using ergonomically positioned padding and adjustable straps, thereby reducing strain and promoting load balance. Through these combined features, the device directly addresses the physical challenges and operational inefficiencies associated with traditional stroller wagon pulling, offering a more ergonomic solution. In this manner, the body-worn hands-free wagon-pulling strap device overcomes the limitations of existing methods of pulling stroller wagons known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a body-worn hands-free wagon-pulling strap device of the present invention in accordance with the disclosed architecture;

FIG. 2 illustrates a perspective view of one potential embodiment of a body-worn hands-free wagon-pulling strap device of the present invention while looped around a wagon handle and while worn by a user in a cross-body configuration in accordance with the disclosed architecture;

FIG. 3 illustrates a perspective view of a double strap embodiment of a body-worn hands-free wagon-pulling strap device of the present invention in accordance with the disclosed architecture; and

FIG. 4 illustrates a flowchart of a method of using one potential embodiment of a body-worn hands-free wagon-pulling strap device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a body-worn hands-free wagon-pulling strap device that enables hands-free operation to reduce upper limb fatigue. There also exists a long-felt need in the art for a body-worn hands-free wagon-pulling strap device that distributes pulling force across the torso and shoulders to minimize strain and improve ergonomic load sharing. Moreover, there exists a long-felt need in the art for a body-worn hands-free wagon-pulling strap device that facilitates stable motion and enhanced control over a wagon across variable terrain surfaces.

The present invention, in one exemplary embodiment, is comprised of a body-worn hands-free wagon-pulling strap device. The device is designed to allow a user to pull a wagon without the use of hands, while simultaneously engaging the upper body muscles to improve mechanical leverage and distribute the pulling force across the torso and shoulders. This ergonomic configuration minimizes fatigue in the arms and hands and enhances control over uneven surfaces. The hands-free operation further permits the user to maintain stability, carry additional items, or assist children while walking.

The device is comprised of a strap body formed from load-bearing materials such as rubber, thermoplastic elastomers, or high-tensile fibers. The outer surface of the strap body may incorporate a grip area formed from anti-slip coatings or texture finishes to prevent slippage during movement. The strap body may be configured as a single cross-body strap or a pair of shoulder straps. The dual strap arrangement may include a fastening mechanism such as a buckle or clasp to maintain alignment and evenly distribute the load. Padding enclosed within a breathable, moisture-wicking cover may also be included in the strap body, with optional ventilation features to aid in heat and moisture control.

The strap body may attach to a wagon handle either by looping directly or by means of one or more fasteners. The fastener may include a pivot point to allow for directional flexibility, thereby minimizing torsional stress on the user's body during directional changes.

An optional handle loop may be provided for manual operation, enabling the user to alternate between hands-free and manual pulling as needed. The handle may include a grip-enhancing feature to improve control during precise maneuvers.

A method of use is disclosed, comprising the steps of providing the device, selecting and wearing the strap configuration, attaching the strap to a wagon handle, walking to pull the wagon in a hands-free manner, and optionally using the handle loop for manual control.

As a result, the device offers significant benefits by enabling hands-free operation, reducing upper limb strain, and minimizing fatigue. The device further distributes pulling forces across the torso and shoulders using ergonomically placed padding and adjustable straps, thereby enhancing load balance and reducing strain. Through these features, the device addresses the ergonomic shortcomings and inefficiencies of conventional wagon-pulling methods, offering a more effective and user-friendly alternative.

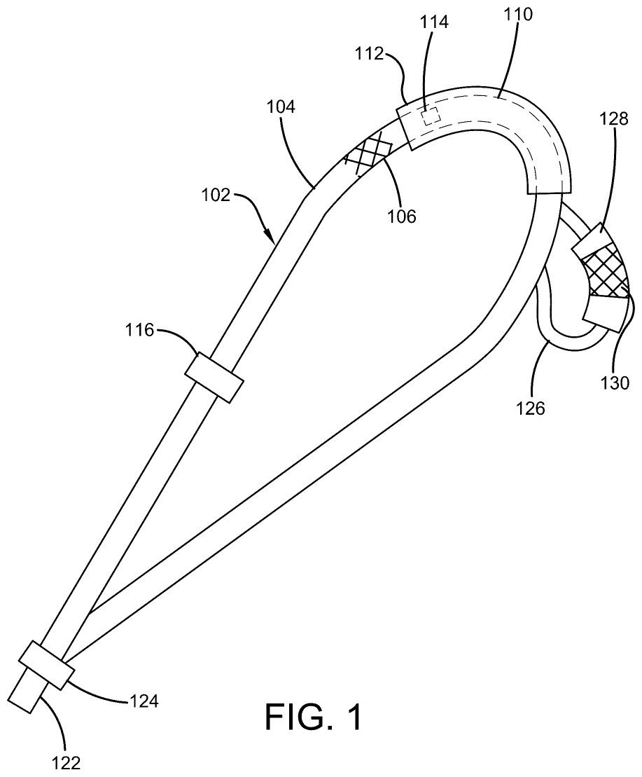

Referring initially to the drawings, FIG. 1 illustrates a perspective view of one potential embodiment of a body-worn hands-free wagon-pulling strap device 100 of the present invention in accordance with the disclosed architecture. The device 100 is a body-worn accessory designed to enable a user to pull a wagon in a hands-free manner. During use, the device 100 allows for the engagement of upper body musculature, thereby enhancing mechanical advantage and distributing pulling force across a user's torso and shoulders. Such a design improves ergonomic load sharing and reduces localized fatigue in the arms and hands. Additionally, the device 100 may offer improved user control during locomotion over irregular or unstable terrain surfaces such as but not limited to gravel, sand, dirt paths, inclined surfaces, or grassy fields. The hands-free configuration may further allow users to maintain dynamic balance, carry additional objects, or provide assistance to children while in motion.

The device 100 may be comprised of a strap body 102. The strap body 102 may be fabricated from materials such as but not limited to natural rubber, thermoplastic elastomers (TPE), woven nylon, woven polyester webbing, webbing resistance band material, polypropylene, high-tensile aramid fibers, or composite textile laminates engineered for load-bearing applications.

In one embodiment, an outer surface 104 of the strap body 102 may be comprised of a grip area 106. The grip area 106 may include a non-slip feature such as but not limited to an anti-slip coating and/or a textured surface. The anti-slip coating may be comprised of materials such as but not limited to silicone-based compounds, polyurethane-based traction layers, or thermoplastic rubber compounds. The textured surface may be comprised of patterns such as but not limited to hexagonal embossing, raised ridges, or microdots, formed from materials such as but not limited to molded thermoplastics, thermoset elastomers, or rubberized fabric overlays. The grip area 106 may be strategically positioned to prevent unwanted movement of the strap body 102 on the user's body during dynamic motion.

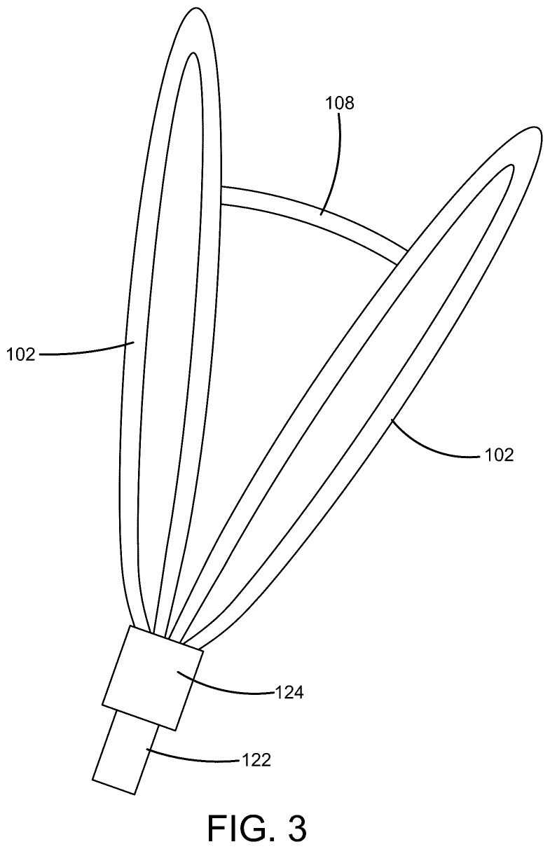

In one embodiment, the strap body 102 may be configured in a single-strap design adapted for cross-body wear, extending diagonally across the torso from one shoulder to the opposite side of the waist, as seen in FIG. 1. In another embodiment, the strap body 102 may be configured in a dual shoulder strap configuration, analogous to a backpack or harness system, as seen in FIG. 3. The dual strap configuration may include a fastener 108 such as but not limited to a connecting chest buckle, sternum strap, magnetic clasp, or quick-release hook to maintain positional alignment and load symmetry across both shoulders.

The strap body 102 may be further comprised of at least one padding 110. The padding 110 may be fabricated from cushioning materials such as but not limited to high-density EVA foam, gel-infused memory foam, closed-cell polyurethane foam, or multi-layered shock-absorbing composites. The padding 110 may be enclosed within a cover 112 comprised of moisture-wicking, breathable materials such as but not limited to perforated neoprene, ventilated mesh, or technical performance textiles treated for antimicrobial and hydrophobic properties. In one embodiment, the padding 110 may incorporate ventilation features 114 such as but not limited to integrated air channels, perforation arrays, or airflow mesh panels to facilitate thermal regulation during use.

In one embodiment, the strap body 102 may include an adjustment fastener 116. The adjustment fastener 116 may be comprised of but is not limited to cam buckles, ladder locks, ratcheting sliders, hook-and-loop strips, or tension locks, enabling precise incremental adjustment of strap length for fit customization and load positioning.

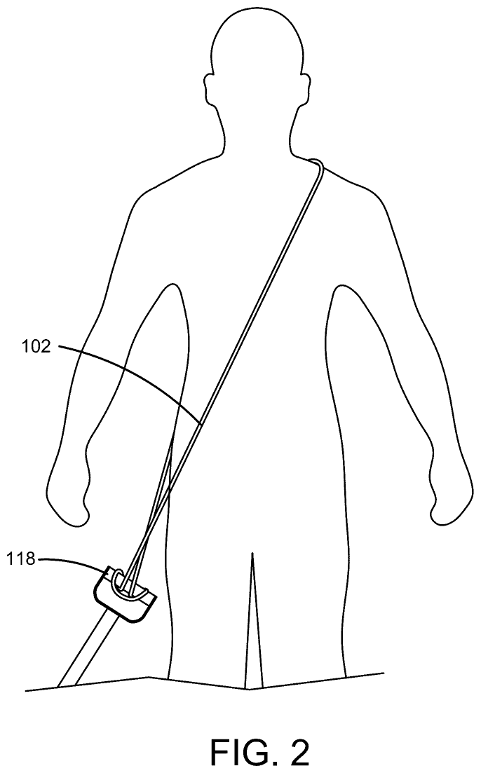

In one embodiment, the strap body 102 may be looped around a wagon handle 118, as seen in FIG. 2, allowing direct mechanical coupling. In an alternate embodiment, the strap body 102 may be comprised of one or more fasteners 122. The fastener 122 may be selected from types such as but not limited to spring-loaded carabiners, gated snap hooks, locking swivel clips, magnetic coupling devices, or pin-and-slot latches. As a result, the fastener 122 may facilitate quick-release attachment and detachment from the wagon handle 118. In one embodiment, each fastener 122 may be comprised of a pivot point 124, such as but not limited to a rotational joint, ball-and-socket connector, or flexible coupler. The pivot point 124 may enable directional compliance, reducing torsional loads transferred to the user's body during cornering, uneven movement, or directional changes.

In one embodiment, the strap body 102 may be further comprised of a handle loop 126. The handle loop 126 may be configured for optional manual grasping by the user, enabling hybrid operation modes between hands-free and hands-on control, particularly in scenarios requiring precision steering or abrupt maneuvering. The loop 126 may be comprised of a handle body 128 that may be any shape. The handle body 128 may be comprised of a grip feature 130 such as but not limited to a texture, a non-slip material, and/or a contour, etc. for improved grip.

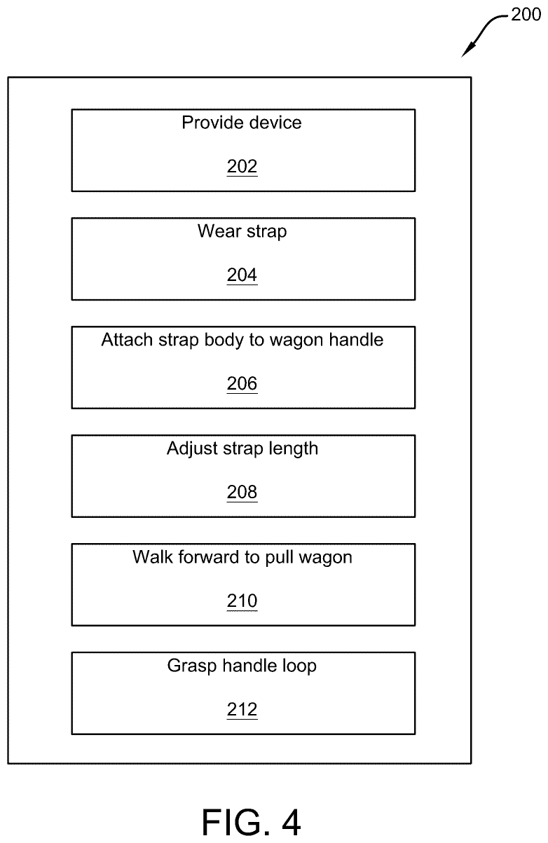

The present invention is also comprised of a method of using 200 the device 100, as seen in FIG. 4. First, a device 100 is provided comprised of a strap body 102 having at least one padding 110 enclosed within a cover 112 and further comprising a grip area 106 on an outer surface 104, at least one adjustment fastener 116, and at least one fastener 122 having a pivot point 124, wherein the strap body 102 may optionally include a handle loop 126 comprised of a handle body 128 and a grip feature 130 [Step 202]. Then, the strap body 102 can be worn by the user in either a cross-body configuration or a dual shoulder strap configuration depending on the embodiment, with optional use of a fastener 108 for positional alignment and load symmetry in the dual shoulder strap configuration [Step 204]. Next, the strap body 102 can be mechanically coupled to a wagon handle 118 by looping the strap body 102 around the handle or by attaching the fastener 122 to the wagon handle 118 to enable pulling engagement [Step 206]. Then, the adjustment fastener 116 (if present) can be operated to incrementally customize the strap length for optimal fit and load distribution based on user preference [Step 208]. Then, the user may walk forward while wearing the device 100 to pull the wagon [Step 210]. Finally, in scenarios requiring manual intervention, the user may optionally grasp the handle loop 126 (if present) by the handle body 128 (if present) and utilize the grip feature 130 (if present) for enhanced control during steering or maneuvering [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “body-worn hands-free wagon-pulling strap device” and “device” are interchangeable and refer to the body-worn hands-free wagon-pulling strap device 100 of the present invention.

Notwithstanding the foregoing, the body-worn hands-free wagon-pulling strap device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the body-worn hands-free wagon-pulling strap device 100 as shown in the FIGS. are for illustrative purposes only, and that many other sizes and shapes of the body-worn hands-free wagon-pulling strap device 100 are well within the scope of the present disclosure. Although the dimensions of the body-worn hands-free wagon-pulling strap device 100 are important design parameters for user convenience, the body-worn hands-free wagon-pulling strap device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A body-worn hands-free wagon-pulling strap device comprising:
a strap body comprised of a padding;
an adjustment fastener; and
a fastener attached to the strap body.

2. The body-worn hands-free wagon-pulling strap device of claim 1, wherein the strap body is comprised of a rubber.

3. The body-worn hands-free wagon-pulling strap device of claim 1, wherein the grip area is comprised of an anti-slip coating.

4. The body-worn hands-free wagon-pulling strap device of claim 3, wherein the anti-slip coating is comprised of a silicone-based compound, a polyurethane-based traction layer, or a thermoplastic rubber compound.

5. The body-worn hands-free wagon-pulling strap device of claim 1, wherein the grip area is comprised of a texture.

6. The body-worn hands-free wagon-pulling strap device of claim 1, wherein the strap body is comprised of a cross-body strap.

7. The body-worn hands-free wagon-pulling strap device of claim 1, wherein the strap body is comprised of a dual shoulder strap.

8. The body-worn hands-free wagon-pulling strap device of claim 7 further comprised of a fastener comprised of a connecting chest buckle, a sternum strap, a magnetic clasp, or a quick-release hook.

9. The body-worn hands-free wagon-pulling strap device of claim 1, wherein the padding is enclosed in a moisture-wicking cover.

10. The body-worn hands-free wagon-pulling strap device of claim 1, wherein the padding is comprised of a ventilation feature.

11. A body-worn hands-free wagon-pulling strap device comprising:
a strap body comprised of a padding and a grip area;
an adjustment fastener; and
a fastener attached to the strap body.

12. The body-worn hands-free wagon-pulling strap device of claim 11, wherein the adjustment fastener is comprised of a cam buckle, a ladder lock, a ratcheting slider, a hook-and-loop strip, or a tension lock.

13. The body-worn hands-free wagon-pulling strap device of claim 11, wherein the fastener is comprised of a spring-loaded carabiner, a gated snap hook, a locking swivel clip, a magnetic coupling device, or a pin-and-slot latch.

14. The body-worn hands-free wagon-pulling strap device of claim 11, wherein the fastener is comprised of a pivot point.

15. The body-worn hands-free wagon-pulling strap device of claim 14, wherein the pivot point is comprised of a rotational joint, a ball-and-socket connector, or a flexible coupler.

16. The body-worn hands-free wagon-pulling strap device of claim 11, wherein the strap body is comprised of a handle loop.

17. The body-worn hands-free wagon-pulling strap device of claim 16, wherein the handle loop is comprised of a handle body.

18. The body-worn hands-free wagon-pulling strap device of claim 17, wherein the handle body is comprised of a grip feature.

19. The body-worn hands-free wagon-pulling strap device of claim 18, wherein the grip feature is comprised of a texture, a non-slip material, or a contour.

20. A method of using a body-worn hands-free wagon-pulling strap device, the method comprising the following steps:
providing a body-worn hands-free wagon-pulling strap device comprised of a strap body comprising a padding and a fastener;
wearing the strap body in either a cross-body configuration or a dual shoulder strap configuration;
mechanically coupling the strap body to a wagon handle of a wagon by looping the strap body around the handle or by attaching the fastener to the wagon handle; and
walking forward while wearing the strap body to pull the wagon by the wagon handle.
